(19) United States
(12) Patent Application Publication
(10) Pub. No.: US 2002/0178873 A1
(43) Pub. Date: Dec. 5, 2002

(54) Shank structure for hand tools

(76) Inventor: Shih-Kuei Hsieh, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/197,853

(22) Filed: Jul. 19, 2002

Related U.S. Application Data
(63) Continuation-in-part of application No. 09/727,577, filed on Dec. 4, 2000.

(51) Int. Cl. B25B 13/00

(52) U.S. Cl. 81/125.1

(57) ABSTRACT

A shank of a hand tool includes two opposite surfaces which are terminated at a rear end of the function end at each of two ends of the shank and two ridges extend from two sides of each of the two opposite surfaces of the shank. The two ridges start from the function end and end at the other function end. The ridges reinforce the structural strength of the shank and provide a larger friction between the hand of the user and the shank.

### FIELD OF THE INVENTION

This application is a Continuation-In-Part application for applicant's former application with application Ser. No. 09/727,577 having the title of “WRENCH HAVING A GRIP WITH BETTER STRENGTH”, filed on Dec. 4, 2000.

### BACKGROUND OF THE INVENTION

FIG. 1 shows a conventional wrench 10 having a grip 12 formed with recessed sections 14 on top and bottom faces. In the recessed sections 14, generally, numerals indicating dimension or a trademark or words describing the material of the wrench are punched. The recessed sections 14 serve to reinforce the grip 12. However, the recessed sections 14 are only formed on a part of the grip 12 and the section 15 free from the recessed section simply has a rectangular cross-section. Therefore, the section 15 has insufficient strength and tends to be broken.

FIG. 2 shows an existent wrench 16 having a grip 18 with a polished surface for enhancing appearance. Such wrench has strip-like cross-section and has a poor structural strength.

More over, the grips 12, 18 of the conventional wrenches 10, 16 have polished surfaces and is liable to slip from a user's hand. The lateral faces 13, 19 of the grips 12, 18 have thin thickness and contact with the user's hand by small area. As a result, the user's hand will suffer a greater stress and feel painful in operation. In addition, the conventional wrenches have metallic monotonous color and lack attractiveness of identification.

### SUMMARY OF THE INVENTION

In accordance with one aspect of the present invention, there is provided a shank of a hand tool and the shank comprises two opposite surfaces which are terminated at a rear end of the function end. Two ridges extend from two sides of each of the two opposite surfaces of the shank and are connected to the function end.

The primary object of the present invention is to provide a shank of a hand tool wherein the ridges on two sides of the shank are connected between the two function ends of the tool so that the shank has stronger structural strength.

Another object of the present invention is to provide a shank of a hand tool wherein the shank can be held without being suffered by painful feeling.

Yet another object of the present invention is to provide a shank of a hand tool wherein the shank has slip-proof effect.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show a conventional wrench;

FIG. 2 is a perspective view to show another conventional wrench;

FIG. 3 is a perspective view to show the wrench of the present invention;

FIG. 4 is a side view to show the ridges of the wrench of the present invention;

FIG. 5 shows the cross section of the shank of the wrench of the present invention;

FIG. 6 shows the ridges are made by rolling the two sides of the shank by rollers;

FIG. 7 shows a another embodiment of the cross section of the shank of the present invention;

FIG. 8 shows that two outer surfaces of the ridges have strips;

FIG. 9 shows how the strips on the outer surfaces are made;

FIG. 10 shows yet another embodiment of the shank of the present invention;

FIG. 11 shows a nut is engaged with the hole in the shank as shown in FIG. 10;

FIG. 12 shows slip-proof material is coated on the two opposite surfaces of the shank of the present invention, and

FIG. 13 is a diagram showing the bending torque and the flexibility of the shank when a force applied onto it.

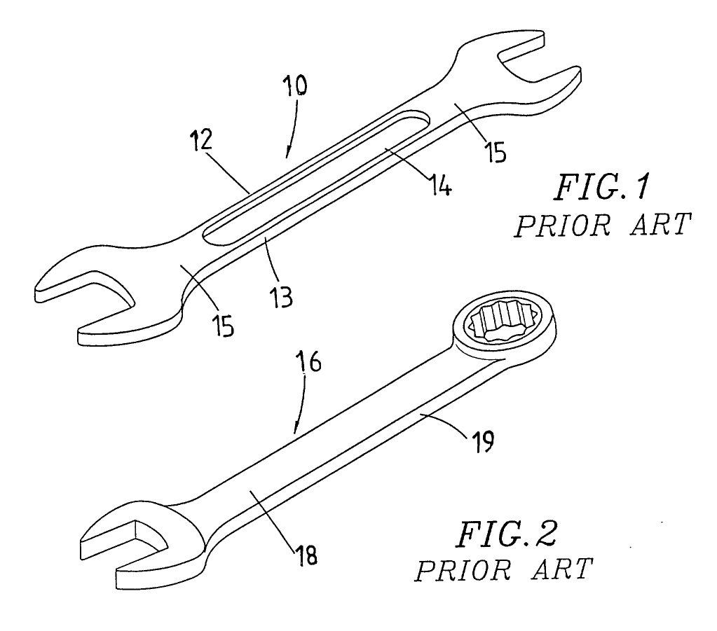

### DETAILED DESCRIPTION OF THE PREFERRED EMBODIMENT

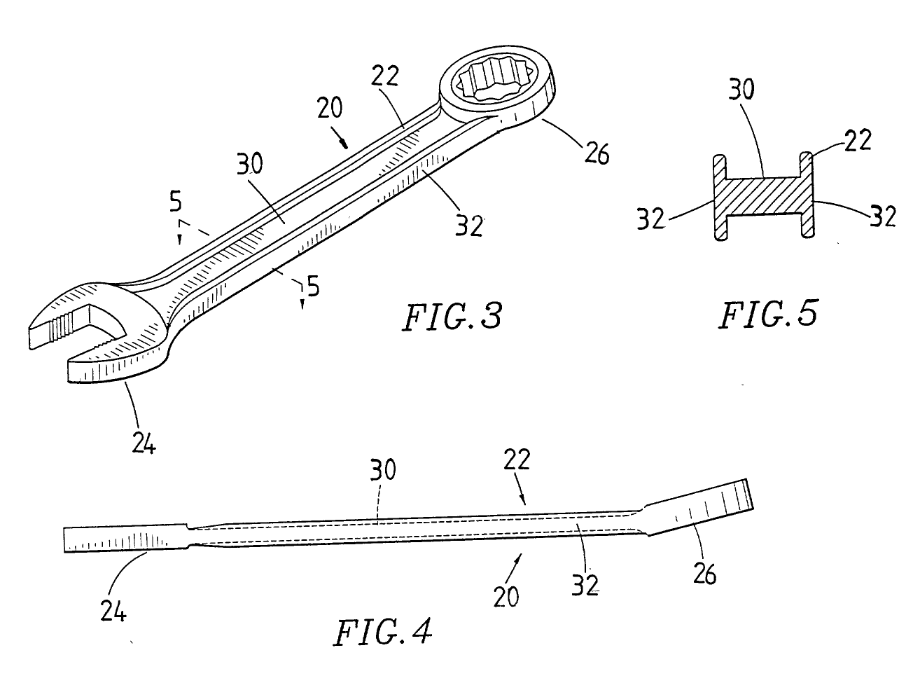

Referring to FIGS. 3 to 5, the hand tool such as a wrench of the present invention comprises a shank 20 which has a function end 24/26 at each of the two ends of the shank 20. In this embodiment the two function ends 24 and 26 are an open-end and a box end.

Two opposite surfaces 30 are defined in the shank and terminated at a rear end of the function ends 24, 26. Two ridges 22 extend from two sides of each of the two opposite surfaces 30 of the shank 20 and are connected to the function ends 24 and 26. Each of the ridges 22 has an outer surface 32 which is perpendicular to each of the two opposite surfaces 30. The outer surfaces 32 are width enough so that the user may hold the shank 20 with larger contact area and this reduce the stress concentration to the hand of the user so that the user feel comfortable.

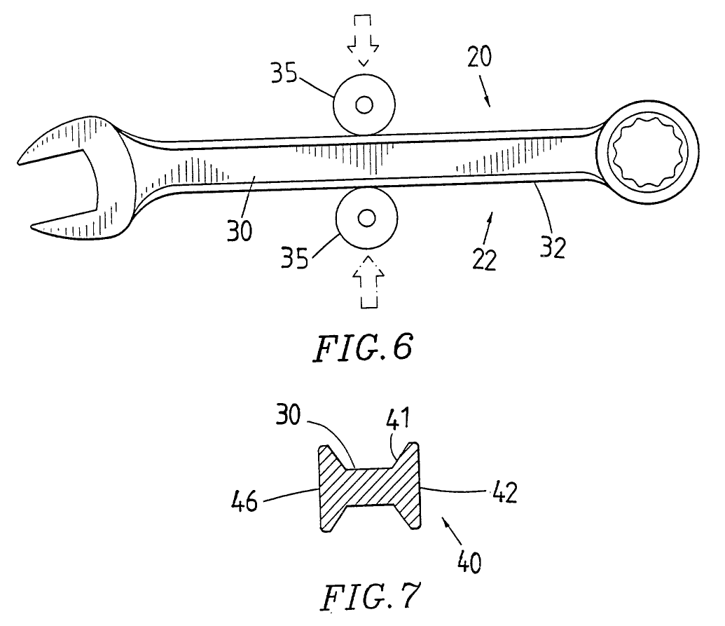

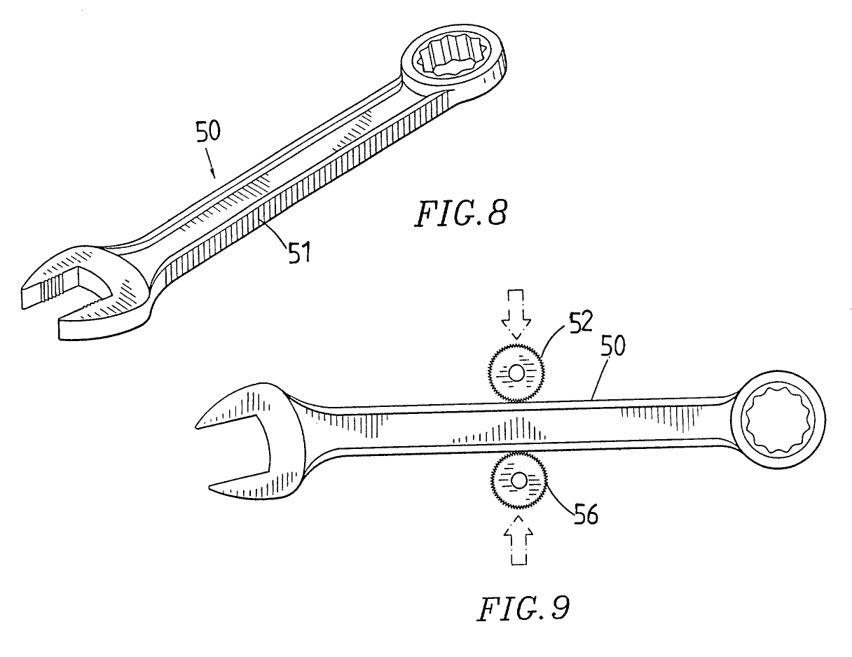

FIG. 6 shows that the two ridges 22 are made by rolling the two sides of the shank 20 by two rollers so as to form the corss section of the shank 20 to be H or I shape.

FIG. 7 shows another embodiment of the ridges 40 which has an inner surface 41 which is extended inclinedly between a top edge of the ridge 40 and the respective one of the two opposite surfaces 30. The outer surface 42 of each of the ridges 40 are perpendicular to the two opposite surfaces 30.

FIG. 8 shows the outer surfaces of the ridges 50 have strips 51 defined therein and the strips 51 protrude from the outer surface of the ridges 50 so as to provide proper friction to the hand of the user. The strips 51 can be conveniently made by using two rollers with teeth 52. Again, the strips 51 increase the friction between the hand of the user and the shank.

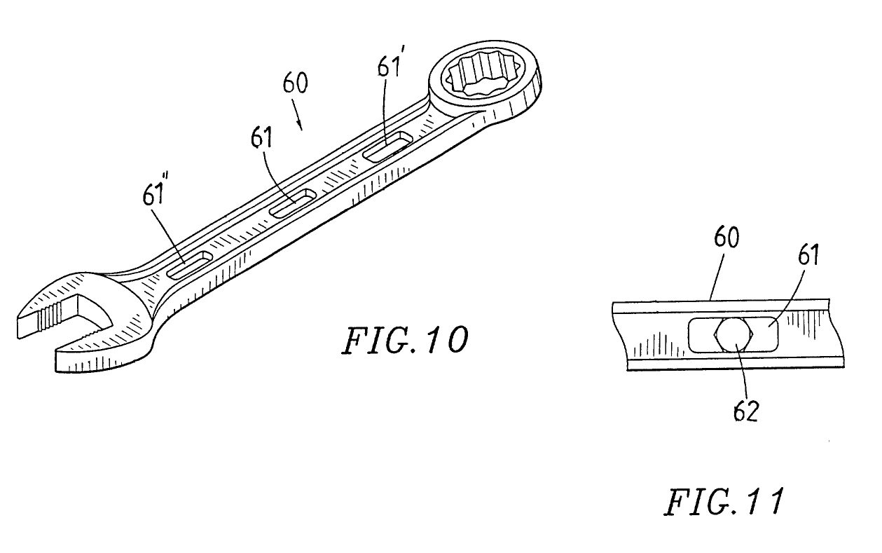

FIGS. 10 and 11 show that three holes 61, 61′, 61″ are defined through the shank 30 and the holes 61, 61′, 61″ have different sizes so as to accommodate a polygonal object such as a nut 62 with different sizes.

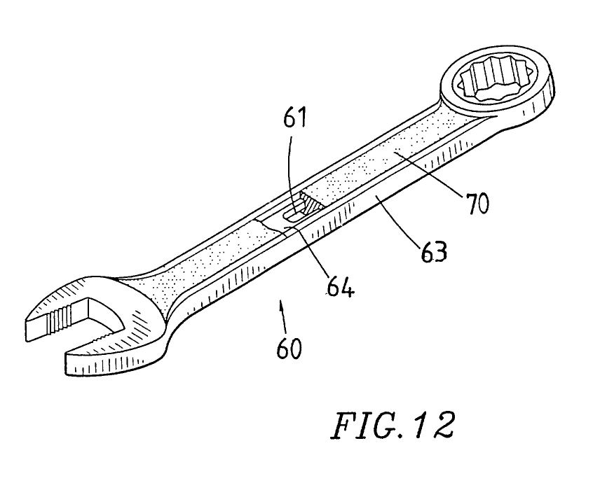

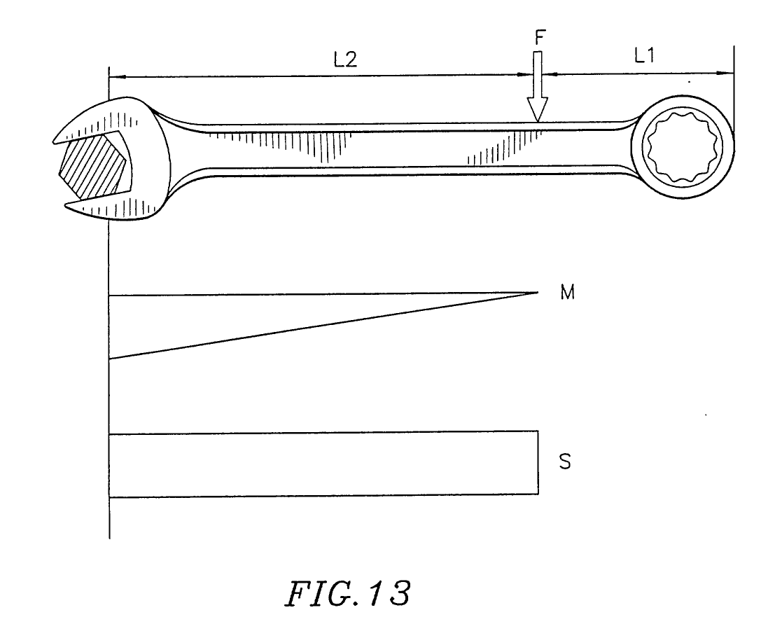

FIG. 12 shows slip-proof material 70 is filled in the space enclosed between the ridges 63 and the two opposite surfaces 64 of the shank 60. The slip-proof material 70 can be a soft material or a material with a certain hardness to make a user comfortably hold the shank 60 and prevent the wrench from slipping away from the user's hand. The slip-proof material can be formed with different colors instead of the monotonous metallic color or the conventional wrench so as to achieve an identification effect and visually attractive effect.

FIG. 13 shows a diagram about a force “F” applying to the shank and the relative data corresponding to the force, wherein

M: bending torque

δ: flexibility

F: action force

Y: Yang's coefficient

I: rotational inertia

S: shearing force

Mₘₐₓ=F×L₂

$$δ = \frac{{FL}_{2}^{3}}{3 YI} ( 1 + \frac{3 {L}_{1}}{2 {L}_{2}} )$$

The shank of the wrench of the present invention has uniform structural strength at every part. When subject to a force, the shank only suffers bending torque and shearing stress. The cross-section of the grip is H-shaped or I-shaped so that it has better structural strength than the conventional wrench. Under the same strength, the wrench of the present invention has lighter weight and smaller volume than the conventional wrench.

While we have shown and described the embodiment in accordance with the present invention, it should be clear to those skilled in the art that further embodiments may be made without departing from the scope of the present invention.

What is claimed is:

1. A shank of a hand tool which has a function end at an end of the shank and the shank comprising:
two opposite surfaces which are adapted to be terminated at a rear end of the function end, two ridges extending from two sides of each of the two opposite surfaces of the shank and adapted to be connected to the function end.

2. The shank as claimed in claim 1, wherein each of the ridges has an outer surface which is perpendicular to each of the two opposite surfaces.

3. The shank as claimed in claim 1, wherein each of the ridges has an inner surface which is extended inclinedly between a top edge of the ridge and the respective one of the two opposite surfaces.

4. The shank as claimed in claim 2 further comprising strips defined in each of the outer surfaces 46 of the ridges.

5. The shank as claimed in claim 1 further comprising at least one hole defined through the shank and adapted to engage with a polygonal object.

6. The shank as claimed in claim 1 further comprising slip-proof material filled in the space enclosed between the ridges and the two opposite surfaces.
